(19) United States
(12) Patent Application Publication
(10) Pub. No.: US 2025/0184800 A1
(43) Pub. Date: Jun. 5, 2025

(54) GAP CONFIGURATION METHOD AND APPARATUS, NETWORK SIDE DEVICE AND STORAGE MEDIUM

(71) Applicant: VIVO MOBILE COMMUNICATION CO., LTD., Dongguan (CN)

(72) Inventors: Xusheng WEI, Dongguan (CN); Xuanbing LIU, Dongguan (CN); Qian YANG, Dongguan (CN)

(21) Appl. No.: 19/043,930

(22) Filed: Feb. 3, 2025

Related U.S. Application Data
(63) Continuation of application No. PCT/CN2023/110109, filed on Jul. 31, 2023.

(30) Foreign Application Priority Data
Aug. 4, 2022 (CN) 2022109348310

(51) Int. Cl. H04W 24/10; H04W 72/231; H04W 88/06

(52) U.S. Cl. CPC H04W 24/10; H04W 72/231; H04W 88/06

(57) ABSTRACT

A gap configuration method and apparatus, a terminal, a network side device, and a storage medium are disclosed which relate to the field of communication technologies. The gap configuration method includes: a terminal receives gap configuration information from a network side device, where the gap configuration information includes configuration information of a first gap pattern configured by the network side device for a multi-universal subscriber identity module (MUSIM) feature of the terminal, and the gap configuration information includes a priority of the first gap pattern.

### CROSS-REFERENCE TO RELATED APPLICATIONS

This application is a bypass continuation application of International Application No. PCT/CN2023/110109, filed on Jul. 31, 2023, which claims the benefit of and priority to Chinese Patent Application No. 202210934831.0, filed on Aug. 4, 2022 and entitled “GAP CONFIGURATION METHOD AND APPARATUS, TERMINAL, NETWORK SIDE DEVICE, AND STORAGE MEDIUM”. The foregoing applications are incorporated herein by reference in their entireties.

### TECHNICAL FIELD

This application pertains to the field of communication technologies and, in particular, to a gap configuration method and apparatus, a terminal, a network side device, and a storage medium.

### BACKGROUND

In radio resource management (RRM) measurement, for inter-frequency measurement and inter-Radio Access Technology (inter-RAT) measurement, since the frequency of an inter-frequency cell or an inter-RAT cell are different from the frequency of a serving cell, a terminal cannot use a same radio frequency chain (RF chain) to simultaneously complete signal transmitting and receiving of the serving cell and measurement of an inter-frequency. Therefore, in a case that a RF chain of the terminal is limited, a gap needs to be introduced into the terminal for measurement. However, when the terminal measures another cell in the gap, the terminal cannot complete receiving from and sending for the serving cell, and consequently, a throughput decreases.

### BRIEF SUMMARY

Embodiments of this application provide a gap configuration method and apparatus, a terminal, a network side device, and a storage medium.

According to a first aspect, a gap configuration method is provided, and the method includes:
receiving, by a terminal, gap configuration information from a network side device, where the gap configuration information includes configuration information of a first gap pattern configured by the network side device for a first feature of the terminal, and the gap configuration information includes a priority of the first gap pattern and/or a priority of the first feature.

According to a second aspect, a gap configuration apparatus is provided, and includes:
a receiving module, configured to receive gap configuration information from a network side device, where the gap configuration information includes configuration information of a first gap pattern configured by the network side device for a first feature of a terminal, and the gap configuration information includes a priority of the first gap pattern and/or a priority of the first feature.

According to a third aspect, a gap configuration method is provided, and the method includes:
sending, by a network side device, gap configuration information to a terminal, where the gap configuration information includes configuration information of a first gap pattern configured by the network side device for a first feature of the terminal, and the gap configuration information includes a priority of the first gap pattern and/or a priority of the first feature.

According to a fourth aspect, a gap configuration apparatus is provided, and includes:
a sending module, configured to send gap configuration information to a terminal, where the gap configuration information includes configuration information of a first gap pattern configured by a network side device for a first feature of the terminal, and the gap configuration information includes a priority of the first gap pattern and/or a priority of the first feature.

According to a fifth aspect, a terminal is provided. The terminal includes a processor and a memory, the memory stores a program or an instruction that can be run on the processor, and when the program or the instruction is executed by the processor, the steps of the method according to the first aspect are implemented.

According to a sixth aspect, a terminal is provided, including a processor and a communication interface. The communication interface is configured to receive gap configuration information from a network side device, where the gap configuration information includes configuration information of a first gap pattern configured by the network side device for a first feature of the terminal, and the gap configuration information includes a priority of the first gap pattern and/or a priority of the first feature.

According to a seventh aspect, a network side device is provided. The network side device includes a processor and a memory, the memory stores a program or an instruction that can be run on the processor, and when the program or the instruction is executed by the processor, the steps of the method according to the third aspect are implemented.

According to an eighth aspect, a network side device is provided, including a processor and a communication interface. The communication interface is configured to send gap configuration information to a terminal, where the gap configuration information includes configuration information of a first gap pattern configured by the network side device for a first feature of the terminal, and the gap configuration information includes a priority of the first gap pattern and/or a priority of the first feature.

According to a ninth aspect, a gap configuration system is provided, including a terminal and a network side device. The terminal may be configured to perform the steps of the gap configuration method according to the first aspect, and the network side device may be configured to perform the steps of the gap configuration method according to the third aspect.

According to a tenth aspect, a readable storage medium is provided. The readable storage medium stores a program or an instruction, and when the program or the instruction is executed by a processor, the steps of the method according to the first aspect are implemented, or the steps of the method according to the third aspect are implemented.

According to an eleventh aspect, a chip is provided. The chip includes a processor and a communication interface, the communication interface is coupled to the processor, and the processor is configured to run a program or an instruction to implement the method according to the first aspect or the method according to the third aspect.

According to a twelfth aspect, a computer program product/program product is provided. The computer program product/program product is stored in a storage medium, and the computer program/program product is executed by at least one processor to implement the steps of the gap configuration method according to the first aspect or the steps of the gap configuration method according to the third aspect.

### BRIEF DESCRIPTION OF DRAWINGS

FIG. 1 is a schematic diagram of a wireless communication system to which embodiments of this application can be applied;

FIG. 2 is a first schematic flowchart of a gap configuration method according to an embodiment of this application;

FIG. 3 is a second schematic flowchart of a gap configuration method according to an embodiment of this application;

FIG. 4 is a diagram of signaling interaction of a gap configuration method according to an embodiment of this application;

FIG. 5 is a first schematic diagram of a structure of a gap configuration apparatus according to an embodiment of this application;

FIG. 6 is a second schematic diagram of a structure of a gap configuration apparatus according to an embodiment of this application;

FIG. 7 is a schematic diagram of a structure of a communication device according to an embodiment of this application;

FIG. 8 is a schematic diagram of a hardware structure of a terminal according to an embodiment of this application; and

FIG. 9 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the term NR is used in most of the following description, although these technologies can also be applied to applications other than the NR system application, such as the 6^{th} generation (6G) communication system.

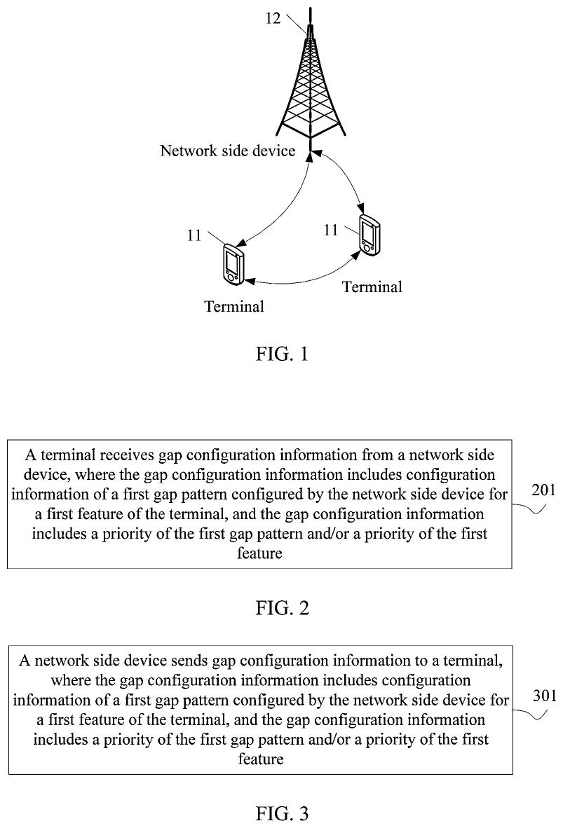

FIG. 1 is a schematic diagram of a wireless communication system to which embodiments of this application can be applied. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a WLAN access point, a WiFi node, and the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another proper term in the art, provided that the same technical effect is achieved. The base station is not limited to a specific technical vocabulary. It should be noted that in the embodiments of this application, a base station in an NR system is merely used as an example for description, but a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application service discovery function (EASDF), unified data management (UDM), unified data repository (UDR), a home subscriber server HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in the NR system is used as an example for description, and a specific type of the core network device is not limited.

In related art, a network configures a plurality of measurement gap patterns for a plurality of features in the terminal, which may lead to a gap conflict. However, in the related technology, there is no solution used to resolve a gap conflict. Lacking of gap confliction solution will lead the network and the terminal have different understandings for a measurement performance requirement, and consequently, the gap cannot be fully used, and a throughput of the terminal is reduced, and measurement time used by the terminal on a measurement object is excessively long.

A gap configuration method and apparatus, a terminal, a network side device, and a storage medium provided in the embodiments of this application are described below in detail by using some embodiments and application scenarios thereof with reference to the accompanying drawings.

Embodiments of this application provide a solution to problems that a gap cannot be fully used due to a gap conflict and consequently, a throughput of a terminal is reduced and measurement time used by the terminal on a measurement object is excessively long. To facilitate a clearer understanding of the embodiments of this application, the following first describes some related technical knowledge.

RRM consistency test is used to test whether a terminal meets a minimum requirement defined in a standard in terms of performance. Consistency test is of great significance for ensuring network interconnection and interworking and user experience of the terminal.

In RRM measurement, for inter-frequency measurement and inter-RAT measurement, because frequencies of an inter-frequency cell and an inter-RAT cell are different from a frequency of a serving cell, a terminal cannot use a same RF chain to simultaneously complete signal receiving and receiving of the serving cell and measurement of an inter-frequency. Therefore, in a case that an RF chain of the terminal is limited, a gap needs to be introduced into the terminal for measurement. When the terminal measures another cell in the gap, because the terminal cannot conduct receiving and sending for the serving cell, a throughput of the terminal is reduced.

In NR Rel-15/16, as in LTE, only one measurement gap pattern can be configured for one terminal. In NR, only one gap pattern can be configured per terminal (per UE). A terminal that uses a frequency range-level measurement gap (per FR gap) can be configured with only one gap pattern in each frequency range (FR). For NR, complexity of the nature of a measurement object is far higher than that in LTE, such as positioning information, a channel state information reference signal (CSI-RS), a multi-universal subscriber identity module (Multi-USIM, MUSIM), or a non-terrestrial networks (NTN). An increase in complexity in time domain is represented by an increase in aperiodic measurement objects, or a plurality of measurement objects (MO) have different periods and offsets. An increase in complexity in frequency domain is represented by a dramatic increase in a possible location of a center frequency of a measurement object. Currently, to ensure that measurement based on a measurement gap is more efficient, it is expected that a plurality of MOs, such as a plurality of synchronization signals/physical broadcast channel blocks (Synchronization Signal/PBCH block, SSB), are aligned as much as possible in time domain, to reduce flexibility of network configuration. To make network configuration more flexible and reduce overheads of a measurement gap, it is planned in R17 to introduce a mechanism for configuring a plurality of measurement gap patterns for one terminal.

In a gap enhancement working item (WI) in R17, a concurrent gap is introduced. At per terminal level (per UE level), a maximum of two simultaneously configured gap patterns are supported. At per frequency range level (per FR level), any FR may support two simultaneously configured gap patterns, and a maximum value in gap patterns of all FRs is 3. In the concurrent gap, each gap pattern is configured with a related priority. When gaps of different gap patterns conflict with each other, which gap is to be reserved and which gap is to be discarded are determined based on the priority.

A gap configuration method provided in the embodiments of this application may be applied to a terminal for which a network side device needs to configure a gap.

FIG. 2 is a first schematic flowchart of a gap configuration method according to an embodiment of this application. As shown in FIG. 2, the method includes step 201.

Step 201: A terminal receives gap configuration information from a network side device, where the gap configuration information includes configuration information of a first gap pattern configured by the network side device for a first feature of the terminal, and the gap configuration information includes a priority of the first gap pattern and/or a priority of the first feature.

Specifically, currently, a solution in R17 to a gap conflict caused when a plurality of gap patterns are configured only depends on a solution that is based on two priorities in a concurrent gap. However, a plurality of features in Rel-17 are configured with required measurement gaps. When a plurality of features are simultaneously configured with measurement gaps and these gaps conflict with each other, there is no corresponding solution at present, which causes the gap conflict cannot be processed. Further, in a case that the network side device (for example, a base station) and the terminal have different understandings for a measurement performance requirement, because the gap conflict cannot be fully used, a throughput of the terminal is further reduced, and measurement time used by the terminal on a related measurement object is prolonged.

Therefore, how to coordinate measurement gaps of different features, and how to deal with a gap conflict problem in a feature or between different features, the solution provided in this embodiment of this application resolves the foregoing problem.

In this embodiment of this application, when configuring a gap for the terminal, the network side device may configure the priority of the first gap pattern and/or the priority of the first feature in the gap configuration information; and the terminal receives the gap configuration information from the network side device, where the gap configuration information includes the configuration information of the first gap pattern configured by the network side device for the first feature of the terminal, and the gap configuration information specifically includes the priority of the first gap pattern and/or the priority of the first feature. In this way, the terminal selects a measurement gap based on a priority configured in the gap configuration information, to avoid a case of a gap conflict, and the gap can be fully used, so that a throughput of the terminal can be improved, and measurement time used by the terminal on a measurement object can also be reduced.

It should be noted that the gap configuration method provided in this embodiment of this application may be applied to both NR and LTE.

In the gap configuration method provided in this embodiment of this application, the terminal receives the gap configuration information from the network side device, where the gap configuration information includes the configuration information of the first gap pattern configured by the network side device for the first feature of the terminal, and the gap configuration information specifically includes the priority of the first gap pattern and/or the priority of the first feature. In this way, the terminal selects a measurement gap based on a priority configured in the gap configuration information, to avoid a case of a gap conflict, and the gap can be fully used, so that a throughput of the terminal can be improved, and measurement time used by the terminal on a measurement object can also be reduced.

Optionally, the first feature may include at least one of the following:

1. Enhanced positioning.

Specifically, enhanced positioning is a feature in R17.

2. Network controlled small gap (NCSG).

3. Pre-configured measurement gap (Pre-MG).

4. Non-terrestrial network (NTN).

Specifically, in Rel-17, the network side device may configure, for example, two periodic measurement gap patterns for the NTN.

5. Multi-universal subscriber identity module (MUSIM).

Specifically, in Rel-17, the network side device may configure, for example, a maximum of three periodic measurement gap patterns for the MUSIM.

Optionally, the priority of the first gap pattern may meet at least one of the following:

(1) The priority of the first gap pattern corresponds to a first identifier of the first gap pattern.

Specifically, the priority of the first gap pattern may be a global or terminal-level priority. The first identifier is, for example, a gap identifier (gap ID). The priority may match the gap ID. One gap ID has a unique priority. Different first identifiers (gap ID) correspond to different priorities. In this way, it is ensured that each priority can be used by only one configured gap, that is, it is ensured that any two different gap patterns use different priorities. In this way, in a case of a gap conflict, regardless of a feature to which two or several conflicting gaps belong, based on an order of priorities, a gap with a low priority may be discarded, and a gap with a high priority is reserved as a measurement gap.

(2) The priority of the first gap pattern corresponds to a second identifier of the first feature.

Specifically, the priority of the first gap pattern may be a priority of the first feature corresponding to the first gap pattern, and the second identifier is, for example, a feature identifier (feature ID). The priority may match the feature ID, and different second identifiers (feature ID) correspond to different priorities.

In an embodiment, in a case that gaps in a same feature conflict with each other, because priorities of first gap patterns in the same feature may be the same and are all equal to a priority corresponding to a feature ID of the same feature, the terminal may determine a gap that needs to be reserved.

(3) Priorities of different gap patterns in each feature are the same or different.

(4) Priorities of different gap patterns belonging to different features are the same or different.

Optionally, in a case that a first gap of the first gap pattern conflicts with a second gap of a second gap pattern of the terminal, the terminal may perform a target operation based on the gap configuration information and a priority of the second gap pattern and/or a priority of a second feature to which the second gap pattern belongs.

The target operation includes at least one of the following:

a. Using the first gap.

Specifically, in a case that the first gap conflicts with the second gap, the terminal may discard the second gap while using the first gap.

b. Using the second gap.

Specifically, in a case that the first gap conflicts with the second gap, the terminal may discard the first gap while using the second gap.

c. Discarding the first gap and the second gap.

d. Determining, based on a terminal implementation, to reserve one of the first gap and the second gap.

Optionally, an implementation in which the terminal performs the target operation based on the gap configuration information and/or the priority of the second gap pattern and/or the priority of the second feature to which the second gap pattern belongs may include at least one of the following:

1. In a case that the priority of the first gap pattern is higher than the priority of the second gap pattern, the terminal uses the first gap.

In an embodiment, in a case that the priority of the first gap pattern is higher than the priority of the second gap pattern, the terminal may reserve and use the first gap as a measurement gap, and discard the second gap.

2. In a case that the priority of the first gap pattern is lower than the priority of the second gap pattern, the terminal uses the second gap.

In an embodiment, in a case that the priority of the first gap pattern is lower than the priority of the second gap pattern, the terminal may reserve and use the second gap as a measurement gap, and discard the first gap.

3. In a case that the priority of the first gap pattern is equal to the priority of the second gap pattern, and the priority of the first gap pattern is not a highest priority, the terminal discards the first gap and the second gap.

In an embodiment, in a case that the priority of the first gap pattern is equal to the priority of the second gap pattern, and the priority of the first gap pattern is not the highest priority, that is, in a case that neither the priority of the first gap pattern nor the priority of the second gap pattern is the highest priority, the terminal may discard the first gap and the second gap, and reserve and use a gap corresponding to a gap pattern with the highest priority as a measurement gap.

In an embodiment, the network side device may force to set a case that priorities of gap patterns of the terminal are not equivalent. For example, when a global priority of the terminal is set, the network side device may force priorities of the gap patterns to be unique.

4. In a case that the priority of the first gap pattern is equal to the priority of the second gap pattern, and the priority of the first gap pattern is a highest priority, the terminal determines, based on a terminal implementation, to reserve one of the first gap and the second gap.

In an embodiment, in a case that the priority of the first gap pattern is equal to the priority of the second gap pattern, and the priority of the first gap pattern is the highest priority, that is, in a case that both the priority of the first gap pattern and the priority of the second gap pattern are the highest priority, the terminal may determine, based on the terminal implementation, to reserve the first gap or the second gap. For example, the terminal may further determine, based on a priority of a feature corresponding to the first gap and a priority of a feature corresponding to the second gap, to reserve and use the first gap or the second gap as a measurement gap.

For example, in a case that the priority of the feature corresponding to the first gap is higher than the priority of the feature corresponding to the second gap, the terminal may reserve and use the first gap as a measurement gap, and discard the second gap; and in a case that the priority of the feature corresponding to the first gap is lower than the priority of the feature corresponding to the second gap, the terminal reserves and uses the second gap as a measurement gap, and discards the first gap.

5. In a case that the priority of the first gap pattern is equal to the priority of the second gap pattern, and the priority of the first feature to which the first gap pattern belongs is higher than the priority of the second feature to which the second gap pattern belongs, the terminal uses the second gap.

6. In a case that the priority of the first gap pattern is equal to the priority of the second gap pattern, and the priority of the first feature to which the first gap pattern belongs is lower than the priority of the second feature to which the second gap pattern belongs, the terminal uses the second gap.

7. In a case that the priority of the first feature to which the first gap pattern belongs is higher than the priority of the second feature to which the second gap pattern belongs, the terminal uses the first gap.

Specifically, the terminal may directly determine, based on a priority of a feature to which a gap pattern belongs, which gap to be reserved and used.

8. In a case that the priority of the first feature to which the first gap pattern belongs is lower than the priority of the second feature to which the second gap pattern belongs, the terminal uses the second gap.

Optionally, the gap configuration information may further include at least one of the following:
(1) the second identifier of the first feature;
(2) the first identifier of the first gap pattern;
(3) frequency information of the first gap pattern;
(4) a length of the first gap pattern;
(5) a type of the first gap pattern, where
specifically, the type of the first gap pattern is, for example, a periodic gap, an aperiodic gap, a one-time gap, a terminal-controlled gap, or a dynamic gap;
(6) a period of the first gap pattern; and
(7) an offset of the first gap pattern.

Optionally, the gap configuration information may be carried by radio resource control (RRC) reconfiguration signaling.

The gap configuration method provided in this embodiment of this application may be applied to a network side device that needs to configure a gap for a terminal.

FIG. 3 is a second schematic flowchart of a gap configuration method according to an embodiment of this application. As shown in FIG. 3, the method includes step 301.

Step 301: A network side device sends gap configuration information to a terminal, where the gap configuration information includes configuration information of a first gap pattern configured by the network side device for a first feature of the terminal, and the gap configuration information includes a priority of the first gap pattern and/or a priority of the first feature.

Specifically, the network side device may send the gap configuration information to the terminal, where the gap configuration information includes the configuration information of the first gap pattern configured by the network side device for the first feature of the terminal, and the gap configuration information specifically includes the priority of the first gap pattern and/or the priority of the first feature. In this way, the terminal receives the gap configuration information from the network side device, and selects a measurement gap based on a priority configured in the gap configuration information, to avoid a case of a gap conflict, and the gap can be fully used, so that a throughput of the terminal can be improved, and measurement time used by the terminal on a measurement object can also be reduced.

It should be noted that the gap configuration method provided in this embodiment of this application may be applied to both NR and LTE.

In the gap configuration method provided in this embodiment of this application, the network side device sends the gap configuration information to the terminal, where the gap configuration information includes the configuration information of the first gap pattern configured by the network side device for the first feature of the terminal, and the gap configuration information specifically includes the priority of the first gap pattern and/or the priority of the first feature. In this way, the terminal selects a measurement gap based on a priority configured in the gap configuration information, to avoid a case of a gap conflict, and the gap can be fully used, so that a throughput of the terminal can be improved, and measurement time used by the terminal on a measurement object can also be reduced.

Optionally, the first feature may include at least one of the following:

1. Enhanced positioning.

2. Network controlled small gap (NCSG).

3. Pre-configured measurement gap (Pre-MG).

4. Non-terrestrial network (NTN).

5. Multi-universal subscriber identity module (MUSIM).

Optionally, the priority of the first gap pattern may meet at least one of the following:

(1) The priority of the first gap pattern corresponds to a first identifier of the first gap pattern.

Specifically, the first identifier is, for example, a gap ID.

(2) The priority of the first gap pattern corresponds to a second identifier of the first feature.

Specifically, the second identifier is, for example, a feature ID.

(3) Priorities of different gap patterns in each feature are the same or different.

(4) Priorities of different gap patterns belonging to different features are the same or different.

Optionally, the gap configuration information may further include at least one of the following:
(1) the second identifier of the first feature;
(2) the first identifier of the first gap pattern;
(3) frequency information of the first gap pattern;
(4) a length of the first gap pattern;
(5) a type of the first gap pattern, where
(6) a period of the first gap pattern; and
(7) an offset of the first gap pattern.

Optionally, the gap configuration information may be carried by RRC reconfiguration signaling.

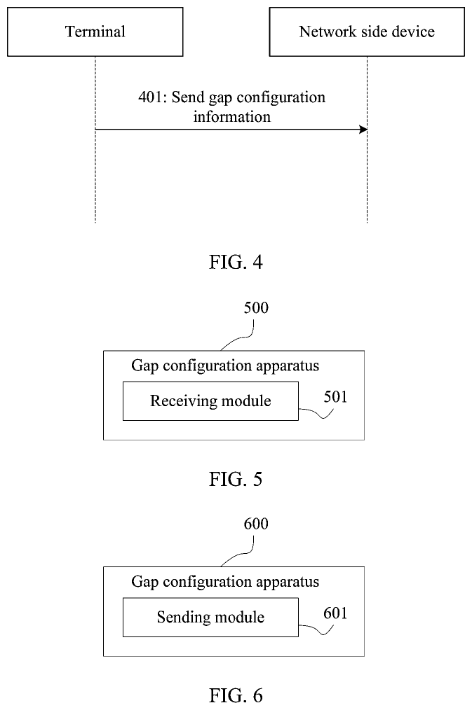

FIG. 4 is a diagram of signaling interaction of a gap configuration method according to an embodiment of this application. As shown in FIG. 4, the method includes step 401.

Step 401: A network side device sends gap configuration information to a terminal.

The gap configuration information includes configuration information of a first gap pattern configured by the network side device for a first feature of the terminal. The gap configuration information includes a priority of the first gap pattern and/or a priority of the first feature.

Specifically, the network side device may send the gap configuration information to the terminal, where the gap configuration information includes the configuration information of the first gap pattern configured by the network side device for the first feature of the terminal, and the gap configuration information specifically includes the priority of the first gap pattern and/or the priority of the first feature. In this way, the terminal receives the gap configuration information from the network side device, and selects a measurement gap based on a priority configured in the gap configuration information, to avoid a case of a gap conflict, and the gap can be fully used, so that a throughput of the terminal can be improved, and measurement time used by the terminal on a measurement object can also be reduced.

The gap configuration method provided in the embodiments of this application is described below as an example.

1. In the gap configuration method provided in the embodiments of this application, a global or per UE level priority may be set for all configured gap patterns, and the priority may match a gap ID. One gap ID has a unique priority, and each priority can be used by only one configured gap pattern, to ensure that any two different gap patterns use different priorities. In a case of a gap conflict, regardless of a feature to which two or several conflicting gaps belong, based on an order of priorities, a gap with a low priority may be discarded, and a gap with a high priority is reserved as a measurement gap.

In a related technology, a measurement gap pattern in Rel-17 is configured as follows:

| | |
|---|---|
| GapConfig-r17 ::= | SEQUENCE { |
| measGapId-r17 | MeasGapId-r17, |
| gap Type-r17 | ENUMERATED {perUE, perFR1, |
| perFR2}, | |
| gapOffset-r17 | INTEGER (0..159), |
| mgl-r17 | ENUMERATED {ms1, ms1dot5, ms2, |

ms3, ms3dot5, ms4, ms5, ms5dot5, ms6, ms10, ms20},

| | |
|---|---|
| mgrp-r17 | ENUMERATED {ms20, ms40, ms80, |
| ms160}, | |
| mgta-r17 | ENUMERATED {ms0, ms0dot25, |
| ms0dot5, ms0dot75}, | |
| refServCellIndicator-r17 | ENUMERATED {pCell, pSCell, |
| mcg-FR2} | |
| OPTIONAL, -- Cond NEDCorNRDC | |
| refFR2-ServCellAsyncCA-r17 | ServCellIndex |
| OPTIONAL, -- Cond AsyncCA | |
| preConfigInd-r17 | ENUMERATED {true} |
| OPTIONAL, -- Need R | |
| ncsgInd-r17 | ENUMERATED {true} |
| OPTIONAL, -- Need R | |
| gap AssociationPRS-r17 | ENUMERATED {true} |
| OPTIONAL, -- Need R | |
| gapSharing-r17 | MeasGapSharingScheme |
| OPTIONAL, -- Need R | |
| gapPriority-r17 | GapPriority-r17 |
| OPTIONAL, -- Need R | |
| ... | |
| } | |
| GapPriority-r17 ::= | INTEGER (1..maxNrOfGapPri- |
| r17) | |

Understandably, although a priority is set in the configuration of the measurement gap pattern in the related technology, no priority is set for another feature in the measurement gap pattern in Rel-17. Due to whether different features are enabled or not and the enabling time differ, a global priority cannot be set for gaps configured for all enabled features in a current framework.

In this embodiment of this application, a global priority may be set for all configured gap patterns, a priority information element (IE) in R17 is redefined, and during configuration of a gap, each feature is configured with a priority attribute related to the gap.

The gap priority IE is redefined, for example:

| | |
|---|---|
| GapPriority-r18 ::= | INTEGER (1..maxNrOfGapPri- |
| r18) | |

It should be noted that no gap priority is configured for some features in R17 in the related technology. For example, a related priority cannot be configured during configuration of the following Rel-17 MUSIM gap.

| | |
|---|---|
| MUSIM-GapConfig-r17 ::= | SEQUENCE { |

Musim-GapToReleaseList-r17 SEQUENCE (SIZE (1..2)) OF MUSIM-GapID-r17

| OPTIONAL, | |
|---|---|
| musim-GapToAddModList-r17 | SEQUENCE (SIZE (1..2)) OF MUSIM- |
| GapInfo-r17 | |
| OPTIONAL, | |
| musim-AperiodicGap-r17 | MUSIM-GapInfo-r17 OPTIONAL, |
| -- Need N | |
| ... | |
| } | |

However, in this embodiment of this application, related signaling may be upgraded as follows:

| | |
|---|---|
| MUSIM-GapConfig-r18 ::= | SEQUENCE { |
| musim-GapToReleaseList-r18 | SEQUENCE (SIZE (1..2)) OF MUSIM- |
| GapID-r18 | |
| OPTIONAL, | |
| musim-GapToAddModList-r18 | SEQUENCE (SIZE (1..2)) OF MUSIM- |
| GapInfo-r18 | |
| OPTIONAL, | |
| musim-AperiodicGap-r18 | MUSIM-GapInfo-r18 OPTIONAL, |
| -- Need N | |
| gapPriority-r18 | GapPriority-r18 |
| OPTIONAL, -- Need R | |
| ... | |
| } | |

2. In the gap configuration method provided in the embodiments of this application, a priority of a gap pattern may be set for each feature. Different gap patterns in each feature may have a same priority, and gap patterns between different features may also have a same priority. In a case of a gap conflict, if two or several conflicting gaps have different priorities, a gap with a low priority is discarded, and only a gap with a highest priority is reserved. When there are gaps with a same priority in the conflicting gaps, if the priority of these gaps is the highest among the conflicting gaps (if they are not the highest, all the gaps are discarded), it is determined based on a terminal implementation which gap is to be reserved and which gap is to be discarded in these gaps with the same priority.

For example, when configuring a related gap for each feature, the network side device configures a priority. Different gap patterns in each feature may have a same priority, and different gap patterns in different features may also have a same priority. When gaps conflict with each other, if there are gaps with a same priority in the conflicting gaps, and the priority is a highest priority, it is determined based on the terminal implementation which gap is to be reserved and which gap is to be discarded in these gaps with the same priority.

In an example of Rel-17 MUSIM, the following method may be used to set a priority when a gap is configured for the MUSIM.

| | |
|---|---|
| MUSIM-GapConfig-r18 ::= | SEQUENCE { |
| musim-GapToReleaseList-r18 | SEQUENCE (SIZE (1..2)) OF MUSIM- |
| GapID-r18 | |
| OPTIONAL, | |

musim-GapToAddModList-r18 SEQUENCE (SIZE (1..2)) OF MUSIM-GapInfo-

| | | |
|---|---|---|
| r18 | | |
| OPTIONAL, | | |
| musim-AperiodicGap-r18 | MUSIM-GapInfo-r18 | OPTIONAL, |
| -- Need N | | |
| musim-gapPriority-r18 | MUSIM-GapPriority-r18 | |
| OPTIONAL, -- Need R | | |
| ... | | |
| } | | |
| MUSIM-GapPriority-r18 := | | INTEGER |
| (1..maxNrOfMUSIMGapPri-r18) | | |

The gap configuration method provided in the embodiments of this application resolves a problem of how to deal with a gap conflict between different features and a gap conflict in a same feature, and avoids a problem that a gap cannot be fully used because a gap conflict cannot be processed and consequently, a throughput of the terminal is reduced and measurement time used by the terminal on a measurement object is excessively long.

The gap configuration method provided in the embodiments of this application may be performed by a gap configuration apparatus. In this embodiment of this application, an example in which the gap configuration method is performed by the gap configuration apparatus is used to describe the gap configuration apparatus provided in this embodiment of this application.

FIG. 5 is a first schematic diagram of a structure of a gap configuration apparatus according to an embodiment of this application. As shown in FIG. 5, the gap configuration apparatus 500 is applied to a terminal and includes:
a receiving module 501, configured to receive gap configuration information from a network side device, where the gap configuration information includes configuration information of a first gap pattern configured by the network side device for a first feature of the terminal, and the gap configuration information includes a priority of the first gap pattern and/or a priority of the first feature.

In the gap configuration apparatus provided in this embodiment of this application, the receiving module of the terminal receives the gap configuration information from the network side device, where the gap configuration information includes the configuration information of the first gap pattern configured by the network side device for the first feature of the terminal, and the gap configuration information specifically includes the priority of the first gap pattern and/or the priority of the first feature. In this way, the terminal selects a measurement gap based on a priority configured in the gap configuration information, to avoid a case of a gap conflict, and the gap can be fully used, so that a throughput of the terminal can be improved, and measurement time used by the terminal on a measurement object can also be reduced.

Optionally, the first feature may include at least one of the following:

1. Enhanced positioning.

2. Network controlled small gap (NCSG).

3. Pre-configured measurement gap (Pre-MG).

4. Non-terrestrial network (NTN).

5. Multi-universal subscriber identity module (MUSIM).

Optionally, the priority of the first gap pattern may meet at least one of the following:

(1) The priority of the first gap pattern corresponds to a first identifier of the first gap pattern.

(2) The priority of the first gap pattern corresponds to a second identifier of the first feature.

(3) Priorities of different gap patterns in each feature are the same or different.

(4) Priorities of different gap patterns belonging to different features are the same or different.

Optionally, the gap configuration apparatus 500 may further include:
a processing module, configured to: in a case that a first gap of the first gap pattern conflicts with a second gap of a second gap pattern of the terminal, perform a target operation based on the gap configuration information and a priority of the second gap pattern and/or a priority of a second feature to which the second gap pattern belongs.

The target operation includes at least one of the following:
a. using the first gap;
b. using the second gap;
c. discarding the first gap and the second gap; and
d. determining, based on a terminal implementation, to reserve one of the first gap and the second gap.

Optionally, an implementation in which the terminal performs the target operation based on the gap configuration information and/or the priority of the second gap pattern and/or the priority of the second feature to which the second gap pattern belongs may include at least one of the following:

1. In a case that the priority of the first gap pattern is higher than the priority of the second gap pattern, the terminal uses the first gap.

2. In a case that the priority of the first gap pattern is lower than the priority of the second gap pattern, the terminal uses the second gap.

3. In a case that the priority of the first gap pattern is equal to the priority of the second gap pattern, and the priority of the first gap pattern is not a highest priority, the terminal discards the first gap and the second gap.

4. In a case that the priority of the first gap pattern is equal to the priority of the second gap pattern, and the priority of the first gap pattern is a highest priority, the terminal determines, based on a terminal implementation, to reserve one of the first gap and the second gap.

5. In a case that the priority of the first gap pattern is equal to the priority of the second gap pattern, and the priority of the first feature to which the first gap pattern belongs is higher than the priority of the second feature to which the second gap pattern belongs, the terminal uses the first gap.

6. In a case that the priority of the first gap pattern is equal to the priority of the second gap pattern, and the priority of the first feature to which the first gap pattern belongs is lower than the priority of the second feature to which the second gap pattern belongs, the terminal uses the second gap.

7. In a case that the priority of the first feature to which the first gap pattern belongs is higher than the priority of the second feature to which the second gap pattern belongs, the terminal uses the first gap.

8. In a case that the priority of the first feature to which the first gap pattern belongs is lower than the priority of the second feature to which the second gap pattern belongs, the terminal uses the second gap.

Optionally, the gap configuration information may further include at least one of the following:
(1) the second identifier of the first feature;
(2) the first identifier of the first gap pattern;
(3) frequency information of the first gap pattern;
(4) a length of the first gap pattern;
(5) a type of the first gap pattern;
(6) a period of the first gap pattern; and
(7) an offset of the first gap pattern.

Optionally, the gap configuration information may be carried by RRC reconfiguration signaling.

FIG. 6 is a second schematic diagram of a structure of a gap configuration apparatus according to an embodiment of this application. As shown in FIG. 6, the gap configuration apparatus 600 is applied to a network side device and includes:
a sending module 601, configured to send gap configuration information to a terminal, where the gap configuration information includes configuration information of a first gap pattern configured by the network side device for a first feature of the terminal, and the gap configuration information includes a priority of the first gap pattern and/or a priority of the first feature.

In the gap configuration method provided in this embodiment of this application, the sending module of the network side device sends the gap configuration information to the terminal, where the gap configuration information includes the configuration information of the first gap pattern configured by the network side device for the first feature of the terminal, and the gap configuration information specifically includes the priority of the first gap pattern and/or the priority of the first feature. In this way, the terminal selects a measurement gap based on a priority configured in the gap configuration information, to avoid a case of a gap conflict, and the gap can be fully used, so that a throughput of the terminal can be improved, and measurement time used by the terminal on a measurement object can also be reduced.

Optionally, the first feature may include at least one of the following:

1. Enhanced positioning.

2. Network controlled small gap (NCSG).

3. Pre-configured measurement gap (Pre-MG).

4. Non-terrestrial network (NTN).

5. Multi-universal subscriber identity module (MUSIM).

Optionally, the priority of the first gap pattern may meet at least one of the following:

(1) The priority of the first gap pattern corresponds to a first identifier of the first gap pattern.

(2) The priority of the first gap pattern corresponds to a second identifier of the first feature.

(3) Priorities of different gap patterns in each feature are the same or different.

(4) Priorities of different gap patterns belonging to different features are the same or different.

Optionally, the gap configuration information may further include at least one of the following:
(1) the second identifier of the first feature;
(2) the first identifier of the first gap pattern;
(3) frequency information of the first gap pattern;
(4) a length of the first gap pattern;
(5) a type of the first gap pattern;
(6) a period of the first gap pattern; and
(7) an offset of the first gap pattern.

Optionally, the gap configuration information may be carried by RRC reconfiguration signaling.

The gap configuration apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The gap configuration apparatus provided in this embodiment of this application can implement the processes implemented in the method embodiments of FIG. 2 to FIG. 4, and a same technical effect is achieved. To avoid repetition, details are not described herein again.

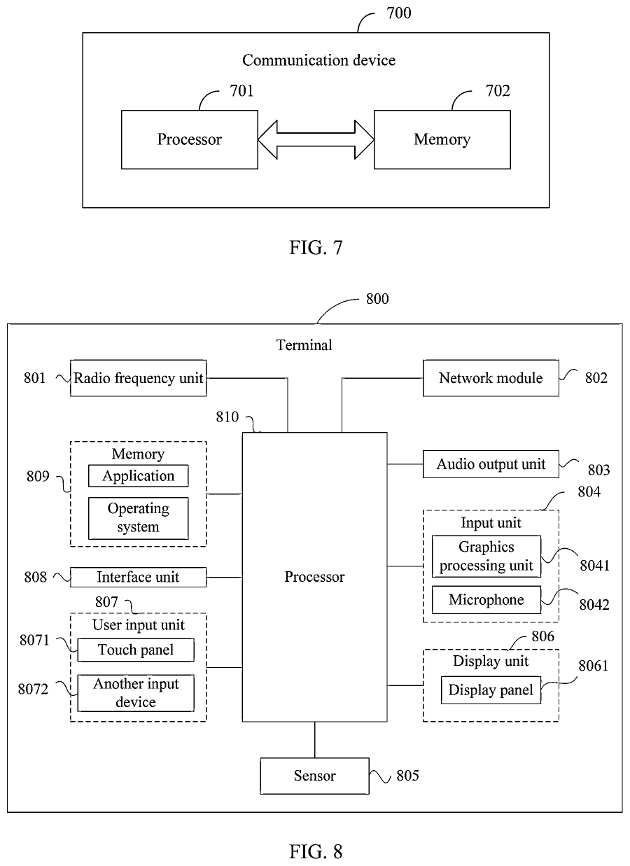

Optionally, FIG. 7 is a schematic diagram of a structure of a communication device according to an embodiment of this application. As shown in FIG. 7, an embodiment of this application further provides a communication device 700, including a processor 701 and a memory 702, and the memory 702 stores a program or an instruction that can be run on the processor 701. For example, in a case that the communication device 700 is a terminal, when the program or the instruction is executed by the processor 701, the steps of the foregoing embodiment of the gap configuration method on the terminal side are implemented, and a same technical effect can be achieved. In a case that the communication device 700 is a network side device, when the program or the instruction is executed by the processor 701, the steps of the foregoing embodiment of the gap configuration method performed by the network side device are implemented, and a same technical effect can be achieved. To avoid repetition, details are not described herein again.

An embodiment of this application further provides a terminal, including a processor and a communication interface. The communication interface is configured to receive gap configuration information from a network side device, where the gap configuration information includes configuration information of a first gap pattern configured by the network side device for a first feature of the terminal, and the gap configuration information includes a priority of the first gap pattern and/or a priority of the first feature. The terminal embodiment corresponds to the method embodiment on the terminal side, each implementation process and implementation manner of the method embodiment can be applied to the terminal embodiment, and a same technical effect can be achieved. Specifically, FIG. 8 is a schematic diagram of a hardware structure of a terminal according to an embodiment of this application.

As shown in FIG. 8, the terminal 800 includes but is not limited to at least some components in a radio frequency unit 801, a network module 802, an audio output unit 803, an input unit 804, a sensor 805, a display unit 806, a user input unit 807, an interface unit 808, a memory 809, a processor 810, and the like.

A person skilled in the art can understand that the terminal 800 may further include a power supply (such as a battery) that supplies power to each component. The power supply may be logically connected to the processor 810 by using a power supply management system, to implement functions such as charging and discharging management, and power consumption management by using the power supply management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 804 may include a graphics processing unit (GPU) 8041 and a microphone 8042. The graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area for storing a program or an instruction and a second storage area for storing data. The first storage area may store an operating system, and an application or an instruction required by at least one function (for example, a sound playing function or an image playing function). In addition, the memory 809 may be a volatile memory or a non-volatile memory, or the memory 809 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 809 in this embodiment of this application includes but is not limited to these memories and any memory of another proper type.

The processor 810 may include one or more processing units. Optionally, an application processor and a modem processor are integrated into the processor 810. The application processor mainly processes an operating system, a user interface, an application, or the like. The modem processor mainly processes a wireless communication signal, for example, a baseband processor. It may be understood that, alternatively, the modem processor may not be integrated into the processor 810.

An embodiment of this application further provides a network side device, including a processor and a communication interface. The communication interface is configured to send gap configuration information to a terminal, where the gap configuration information includes configuration information of a first gap pattern configured by the network side device for a first feature of the terminal, and the gap configuration information includes a priority of the first gap pattern and/or a priority of the first feature. This network side device embodiment corresponds to the foregoing method embodiment on the network side device. Each implementation process and implementation manner of the foregoing method embodiment may be applicable to this network side device embodiment, and a same technical effect can be achieved.

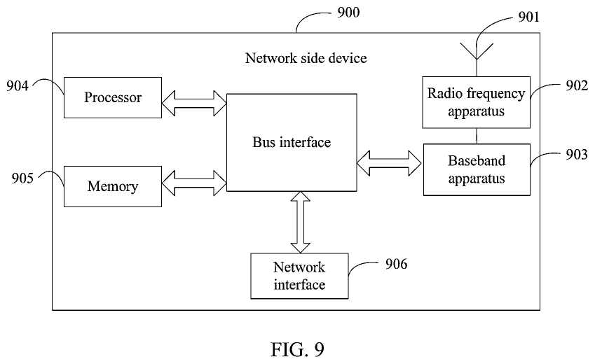

Specifically, an embodiment of this application further provides a network side device. FIG. 9 is a schematic diagram of a structure of a network side device according to an embodiment of this application. As shown in FIG. 9, the network side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes information that needs to be sent, and sends processed information to the radio frequency apparatus 902. The radio frequency apparatus 902 processes the received information, and sends processed information through the antenna 901.

In the foregoing embodiment, the method performed by the network side device may be implemented in the baseband apparatus 903. The baseband apparatus 903 includes a baseband processor.

For example, the baseband apparatus 903 may include at least one baseband board. A plurality of chips are disposed on the baseband board. As shown in FIG. 9, one chip is, for example, a baseband processor, and is connected to the memory 905 by using a bus interface, to invoke a program in the memory 905 to perform the operations of the network device shown in the foregoing method embodiment.

The network side device may further include a network interface 906, and the interface is, for example, a common public radio interface (CPRI).

Specifically, the network side device 900 in this embodiment of this application further includes an instruction or a program that is stored in the memory 905 and that can run on the processor 904. The processor 904 invokes the instruction or the program in the memory 905 to perform the foregoing gap configuration method of the network side device, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing embodiment of the gap configuration method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the gap configuration method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the gap configuration method, and a same technical effect can be achieved. To avoid repetition, details are not described herein again.

An embodiment of this application further provides a gap configuration system, including a terminal and a network side device. The terminal may be configured to perform the steps of the gap configuration method on the terminal side, and the network side device may be configured to perform the steps of the gap configuration method of the network side device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an optional implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A gap configuration method, comprising:
receiving, by a terminal, gap configuration information from a network side device, wherein the gap configuration information comprises configuration information of a first gap pattern configured by the network side device for a multi-universal subscriber identity module (MUSIM) feature of the terminal, and the gap configuration information comprises a priority of the first gap pattern.

2. The gap configuration method according to claim 1, further comprising:
in a case that a first gap of the first gap pattern conflicts with a second gap of a second gap pattern of the terminal, resolving collisions sequentially in order of decreasing priority, starting with a gap that has the highest priority.

3. The gap configuration method according to claim 1, wherein the priority of the first gap pattern meets:
the priority of the first gap pattern corresponds to a first identifier of the first gap pattern; or
priorities of different gap patterns in the MUSIM feature are different.

4. The gap configuration method according to claim 3, wherein the method further comprises:
in a case that a first gap of the first gap pattern conflicts with a second gap of a second gap pattern of the terminal, performing, by the terminal, a target operation based on the gap configuration information and a priority of the second gap pattern; wherein
the target operation comprises at least one of the following:
using the first gap;
using the second gap;
discarding the first gap and the second gap; and
determining, based on a terminal implementation, to reserve one of the first gap and the second gap.

5. The gap configuration method according to claim 4, wherein the performing, by the terminal, a target operation based on the gap configuration information and a priority of the second gap pattern comprises at least one of the following:
in a case that the priority of the first gap pattern is higher than the priority of the second gap pattern, using, by the terminal, the first gap;
in a case that the priority of the first gap pattern is lower than the priority of the second gap pattern, using, by the terminal, the second gap;
in a case that the priority of the first gap pattern is equal to the priority of the second gap pattern, and the priority of the first gap pattern is not a highest priority, discarding, by the terminal, the first gap and the second gap; or
in a case that the priority of the first gap pattern is equal to the priority of the second gap pattern, and the priority of the first gap pattern is a highest priority, determining, by the terminal based on the terminal implementation, to reserve one of the first gap and the second gap.

6. The gap configuration method according to claim 1, wherein the gap configuration information further comprises at least one of the following:
the second identifier of the MUSIM feature;
the first identifier of the first gap pattern;
frequency information of the first gap pattern;
a length of the first gap pattern;
a type of the first gap pattern;
a period of the first gap pattern; and
an offset of the first gap pattern.

7. The gap configuration method according to claim 1, wherein the gap configuration information is carried by radio resource control RRC reconfiguration signaling.

8. A gap configuration method, comprising:
sending, by a network side device, gap configuration information to a terminal, wherein the gap configuration information comprises configuration information of a first gap pattern configured by the network side device for a multi-universal subscriber identity module (MUSIM) feature of the terminal, and the gap configuration information comprises a priority of the first gap pattern.

9. The gap configuration method according to claim 8, wherein, in a case that a first gap of the first gap pattern conflicts with a second gap of a second gap pattern of the terminal, collisions are resolved sequentially in order of decreasing priority, starting with a gap that has the highest priority.

10. The gap configuration method according to claim 8, wherein the priority of the first gap pattern meets:
the priority of the first gap pattern corresponds to a first identifier of the first gap pattern; or
priorities of different gap patterns in the MUSIM feature are different.

11. The gap configuration method according to claim 8, wherein the gap configuration information further comprises at least one of the following:
the second identifier of the MUSIM feature;
the first identifier of the first gap pattern;
frequency information of the first gap pattern;
a length of the first gap pattern;
a type of the first gap pattern;
a period of the first gap pattern; and
an offset of the first gap pattern.

12. The gap configuration method according to claim 8, wherein the gap configuration information is carried by radio resource control RRC reconfiguration signaling.

13. A terminal, comprising at least one hardware processor and a memory, wherein the memory stores a program or an instruction that is capable of being executed by the at least one hardware processor, and the at least one hardware processor, through executing the program or the instruction, is configured to:
receive gap configuration information from a network side device, wherein the gap configuration information comprises configuration information of a first gap pattern configured by the network side device for a multi-universal subscriber identity module (MUSIM) feature of the terminal, and the gap configuration information comprises a priority of the first gap pattern.

14. The terminal according to claim 13, wherein the processor is further configured to:
in a case that a first gap of the first gap pattern conflicts with a second gap of a second gap pattern of the terminal, resolve collisions sequentially in order of decreasing priority, starting with a gap that has the highest priority.

15. The terminal according to claim 13, wherein the priority of the first gap pattern meets:
the priority of the first gap pattern corresponds to a first identifier of the first gap pattern; or
priorities of different gap patterns in the MUSIM feature are different.

16. The terminal according to claim 15, wherein the method further comprises:
in a case that a first gap of the first gap pattern conflicts with a second gap of a second gap pattern of the terminal, performing, by the terminal, a target operation based on the gap configuration information and a priority of the second gap pattern; wherein
the target operation comprises at least one of the following:
using the first gap;
using the second gap;
discarding the first gap and the second gap; and
determining, based on a terminal implementation, to reserve one of the first gap and the second gap.

17. The terminal according to claim 16, wherein the performing, by the terminal, a target operation based on the gap configuration information and a priority of the second gap pattern comprises at least one of the following:
in a case that the priority of the first gap pattern is higher than the priority of the second gap pattern, using, by the terminal, the first gap;
in a case that the priority of the first gap pattern is lower than the priority of the second gap pattern, using, by the terminal, the second gap;
in a case that the priority of the first gap pattern is equal to the priority of the second gap pattern, and the priority of the first gap pattern is not a highest priority, discarding, by the terminal, the first gap and the second gap; or
in a case that the priority of the first gap pattern is equal to the priority of the second gap pattern, and the priority of the first gap pattern is a highest priority, determining, by the terminal based on the terminal implementation, to reserve one of the first gap and the second gap.

18. The terminal according to claim 13, wherein the gap configuration information further comprises at least one of the following:
the second identifier of the MUSIM feature;
the first identifier of the first gap pattern;
frequency information of the first gap pattern;
a length of the first gap pattern;
a type of the first gap pattern;
a period of the first gap pattern; and
an offset of the first gap pattern.

19. The terminal according to claim 13, wherein the gap configuration information is carried by radio resource control RRC reconfiguration signaling.

20. A network side device, comprising at least one hardware processor and a memory, wherein the memory stores a program or an instruction that is capable of being run on the at least one hardware processor, and when the program or the instruction is executed by the at least one hardware processor, the gap configuration method according to claim 8 are implemented.
